(19) United States
(12) Patent Application Publication
(10) Pub. No.: US 2022/0407053 A1
(43) Pub. Date: Dec. 22, 2022

(54) ANODE ACTIVE MATERIAL, ANODE COMPOSITION INCLUDING THE SAME AND LITHIUM SECONDARY BATTERY INCLUDING THE SAME

(71) Applicant: SK ON CO., LTD., Seoul (KR)

(72) Inventors: Hwan Ho JANG, Daejeon (KR); Sang Baek RYU, Daejeon (KR); Gwi Ok PARK, Daejeon (KR); Ju Ho CHUNG, Daejeon (KR); Moon Sung KIM, Daejeon (KR); Hyo Mi KIM, Daejeon (KR); Seung Hyun YOOK, Daejeon (KR); Jun Hee HAN, Daejeon (KR)

(21) Appl. No.: 17/842,547

(22) Filed: Jun. 16, 2022

(30) Foreign Application Priority Data
Jun. 18, 2021 (KR) 10-2021-0079208

(51) Int. Cl. H01M 4/36; H01M 10/052; H01M 4/38; H01M 4/583

(52) U.S. Cl. CPC H01M 4/364; H01M 10/052; H01M 4/386; H01M 4/583; H01M 2004/027

(57) ABSTRACT

An anode active material including different types of particles, an anode composition including the anode active material and a lithium secondary battery including the anode active material are disclosed. In an aspect, an anode active material includes a carbon-based active material, and a silicon-based active material having a minimum particle diameter (Dmin) in a range from 0.5 μm to 2.5 μm, a volume average particle diameter (D50) in a range from 3.0 μm to 7.0 μm, and a specific surface area in a range from 0.1 m²/g to 2.5 m²/g.

### PRIORITY CLAIM AND CROSS-REFERENCE TO RELATED APPLICATION

This patent document claims the priority and benefits of Korean Patent Application No. 10-2021-0079208 filed at the Korean Intellectual Property Office (KIPO) on Jun. 18, 2021, the entire disclosure of which is incorporated herein by reference.

### TECHNICAL FIELD

The disclosure of this patent document relates to an anode active material, an anode composition including the same and a lithium secondary battery including the same.

### BACKGROUND

The rapid growth of electric vehicles and portable devices, such as camcorders, mobile phones, and laptop computers, has brought increasing demands for secondary batteries, which can be charged and discharged repeatedly. Examples of the secondary batteries include lithium secondary batteries, nickel-cadmium batteries, and nickel-hydrogen batteries. The lithium secondary batteries are now widely used due to high operational voltage and energy density per unit weight, a high charging rate, a compact dimension, etc.

A lithium secondary battery may include an electrode assembly including a cathode, an anode and a separation layer (separator), and an electrolyte immersing the electrode assembly. The lithium secondary battery may further include an outer case having, e.g., a pouch shape for accommodating the electrode assembly and the electrolyte.

For example, the anode may include a carbon-based active material or silicon-based active material particles as an anode active material. When the battery is repeatedly charged and discharged, mechanical and chemical damage such as particle cracks may occur to cause a poor contact between the active material particles or a short-circuit.

If a composition and a structure of the anode active material are changed to improve stability of the active material particles, a conductivity may be degraded and a power of the secondary battery may be deteriorated. Thus, developments of the anode active material capable of enhancing life-span stability and power/capacity properties are needed.

In order to address such issues, some lithium secondary battery designs include an electrode assembly for a lithium secondary battery.

### SUMMARY

This patent document discloses technical features and examples for an anode active material including different types of particles, an anode composition including the same and a lithium secondary battery including the same.

According to an aspect of the disclosed technology, there is provided an anode active material having improved stability and electrical property.

According to an aspect of the disclosed technology, there is provided an anode composition having improved stability and electrical property.

According to an aspect of the disclosed technology, there is provided a lithium secondary battery having improved stability and electrical property.

An anode active material according to embodiments of the disclosed technology includes a carbon-based active material and a silicon-based active material having a minimum particle diameter (Dmin) in a range from 0.5 μm to 2.5 μm, a volume average particle diameter (D50) in a range from 3.0 μm to 7.0 μm, and a specific surface area in a range from 0.1 m²/g to 2.5 m²/g. In some implementations, the carbon-based active material and the silicon-based active material are mixed with each other.

In some embodiments, a volume fraction of particles having a diameter of 1 μm or less in the silicon-based active material may be 5% or less.

In some embodiments, the minimum particle diameter (Dmin) of the silicon-based active material may be in a range from 1.5 μm to 2.5 μm.

In some embodiments, a D10 of the silicon-based active material may be in a range from 1.5 μm to 4.5 μm. In one example, the D10 indicates a particle diameter corresponding to a volume fraction of 10%.

In some embodiments, a D90 of the silicon-based active material may be in a range from 7 μm to 10 μm. In one example, the D90 indicates a particle diameter corresponding to a volume fraction of 90%.

In some embodiments, a number average particle diameter (Dn) of the silicon-based active material may be in a range from 1.0 μm to 5.0 μm.

In some embodiments, a specific surface area of the carbon-based active material may be in a range from 0.1 m²/g to 3 m²/g.

In some embodiments, a volume average particle diameter (D50) of the carbon-based active material may be in a range from 10 μm to 15 μm.

In some embodiments, an amount of the silicon-based active material may be in a range from 5 wt % to 20 wt % based on a total weight of the anode active material.

An anode composition in some embodiments includes a mixture of an anode active material and carbon nanotubes (CNTs).

In some embodiments, a content of the carbon nanotubes (CNTs) in an anode material may be in a range from 0.05 wt % to 1.5 wt % based on a total solid content of the anode composition.

In some embodiments, a content of the carbon nanotubes (CNTs) in an anode material may be in a range from 0.1 wt % to 0.5 wt % based on a total solid content of the anode composition.

In some embodiments, the anode composition may further include a solvent, a binder, a thickener and/or a dispersive agent.

A lithium secondary battery includes an anode including the anode active material according to embodiments as described above, and a cathode facing the anode.

According to exemplary embodiments, the anode active material may include a carbon-based active material and a silicon-based active material having a minimum particle diameter (Dmin), a volumetric average particle diameter (D50) and a specific surface area within predetermined ranges. Improved energy density and charge/discharge capacity may be provided by the silicon-based active material, and electrochemical stability of the anode active material may be improved by the carbon-based active material.

The silicon-based active material may have a larger minimum particle diameter and a low specific surface area, so that a side reaction with an electrolyte and a consumption of the electrolyte due to the side reaction may be reduced. Accordingly, a capacity retention and a high-temperature stability of a secondary battery may be improved.

The silicon-based active material may have a particle size distribution within a predetermined range, so that cracks and a volume expansion of the anode active material during charging and discharging may be prevented. Further, a poor contact between the active material particles or a short-circuit may also be prevented.

The carbon-based active material may have the specific surface area within a predetermined range, so that electron/ion movement paths may be sufficiently provided in an anode. Thus, electrochemical stability of the secondary battery may be improved, and high-capacity and high-rate properties may be obtained.

According to exemplary embodiments, enhanced initial charge/discharge properties and capacity retention may be provided, even when a small amount of a conductive material is included in the anode composition. The secondary battery may also have improved life-span properties even with a reduced amount of the electrolyte or an additive in the electrolyte to provide enhanced high-temperature operational stability.

### BRIEF DESCRIPTION OF THE DRAWINGS

FIG. 1 is a schematic top planar view illustrating a secondary battery according to exemplary embodiments.

FIG. 2 is a schematic cross-sectional view illustrating a secondary battery according to exemplary embodiments.

FIG. 3 is a graph showing volume-weighted particle size distributions of silicon-based active materials according to Synthesis Examples.

FIG. 4 is a graph showing number-weighted particle size distributions of silicon-based active materials according to Synthesis Examples.

### DETAILED DESCRIPTION OF THE EMBODIMENTS

According to exemplary embodiments of the disclosed technology, an anode active material which includes a carbon-based active material and a silicon-based active material having predetermined size and surface properties. Further, an anode composition and a lithium secondary battery including the anode active material are provided.

Hereinafter, various features of the disclosed technology will be described in detail with reference to embodiments and the accompanying drawings.

Anode Active Material

An anode active material (e.g., an anode active material for a secondary battery) according to exemplary embodiments may include a carbon-based active material and a silicon-based active material. For example, the anode active material may be a mixture in which the carbon-based active material and the silicon-based active material are uniformly mixed/dispersed.

A minimum particle diameter (Dmin) of the silicon-based active material may be in a range from 0.5 μm to 2.5 μm. The minimum particle diameter (Dmin) may be measured using a scanning electron microscope (SEM), a transmission electron microscope (TEM), or a light scattering method. In some implementations, the term “particle diameter” may refer to the longest distance between any two points on the outline of a particle.

For example, the minimum particle diameter (Dmin) may refer to the smallest particle diameter measured using a laser diffraction particle size analyzer after dispersing the silicon-based active material in a dispersion medium.

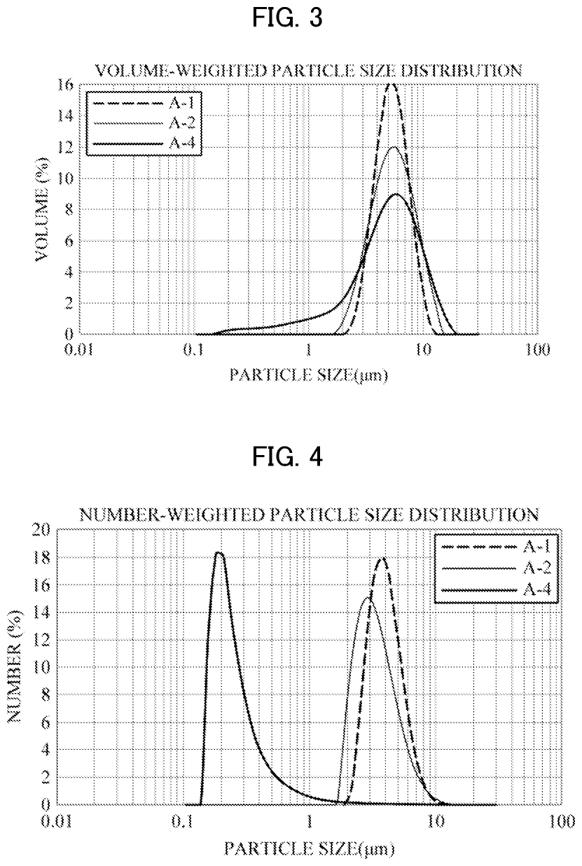

FIGS. 3 and 4 are graphs showing a volume-weighted particle size distribution curve and a number-weighted particle size distribution curve, respectively. For example, in FIGS. 3 and 4, an X-intercept of the particle size distribution curve may indicate the minimum particle diameter (Dmin).

If the minimum particle diameter of the silicon-based active material is less than 0.5 μm, collapse/regeneration of a solid electrolyte interphase (SEI) layer may be increased during repeated charging and discharging, accelerating consumption of an electrolyte. Accordingly, the battery capacity and life-span of the secondary battery may be deteriorated due to a depletion of the electrolyte during charge/discharge cycles.

If the minimum particle diameter of the silicon-based active material is greater than 2.5 μm, a diffusion distance of lithium may be increased to cause reduction of power and rate properties, and an initial capacity of the secondary battery.

In some embodiments, a volume fraction of silicon-based active material particles having a particle diameter of 1 μm or less among the silicon-based active material may be 5% or less. For example, in the volume-weighted particle size distribution, a particle diameter at a volume fraction of 5% may be 1 μm or more. The silicon-based active material may contain a small amount of particles having a particle diameter of 1 μm or less, so that an initial efficiency of the secondary battery may be improved, and expansion and contraction of the active material during the charging and discharging may be reduced.

Preferably, in certain implementations, the silicon-based active material may not include particles having a particle diameter of 1 μm or less. For example, the minimum particle diameter of the silicon-based active material may be greater than 1 μm, and more preferably, in certain implementations, may be in a range from 1.5 μm to 2.5 μm. In the particle diameter range, side reactions due to a contact between the silicon-based active material and the electrolyte may be suppressed, and life-span properties of the secondary battery may be improved by a reversible charging/discharging operation.

The anode active material with mixed carbon-based active material and silicon-based active material may include material particles with different sizes indicated by DX, where X represents a percentage of particles in volume in the material with particle diameters not greater than DX. In one example, DX indicates a diameter of a particle corresponding to a volume fraction of X % in an accumulation from the smallest particles to largest particles. Consider an example of D50 for X=50, a volume average particle diameter (D50) at 4.0 μm for a silicon-based active material represents that there are 50% of the particles in volume in this material with particle diameters less than or equal to 4.0 In other words, a volume average particle diameter (D50) refers to a particle size at 50% of a volume fraction of all particles in the material in an accumulation from the smallest particle to the largest particle using a particle size distribution measured by a particle size analyzer (e.g., utilizing a light scattering method).

In some implementations, a volume average particle diameter (D50) of the silicon-based active material may be in a range from 3.0 μm to 7.0 μm, and preferably, in certain implementations, may be in a range from 4.0 μm to 6.0 μm.

In some implementations, the volume average particle diameter (D50) of the silicon-based active material may be 3 μm or more, so that the anode active material may be uniformly distributed in a composition or a slurry for the anode. Further, a transfer path of ions/electrons in the anode composition may be sufficiently achieved, so that initial capacity and power properties of the secondary battery may be improved.

In some implementations, the volume average particle diameter (D50) of the silicon-based active material may be 7 μm or less, so that cracks and expansion of the active material particles during the charging and discharging may be prevented, and thus a reduction of an energy density may be prevented.

In some implementations, a specific surface area of the silicon-based active material may be 2.5 m²/g or less, e.g., in a range from 0.1 m²/g to 2.5 m²/g. The specific surface area may be measured by suitable methods, including, for example, a Brunaucr-Emmett-Teller (BET) method. In some implementations, if the specific surface area of the silicon-based active material is 0.1 m²/g or more, a contact area between the active material particles may be increased, so that a conductivity of the anode active material may be improved. Accordingly, capacity and cycle properties of the secondary battery may be improved. If the specific surface area of the silicon-based active material is 2.5 m²/g or less, an elution of lithium ions may be suppressed and electrochemical stability of the anode active material may be improved.

Preferably, in certain implementations, the specific surface area of the silicon-based active material may be in a range from 1 m²/g to 2 m²/g. Within the above range, the side reactions during the charging and discharging may be suppressed, and an irreversible decomposition of the electrolyte and a resistance increase may be prevented.

For example, the silicon-based active material may have a non-porous structure. If the silicon-based active material has a porous structure, the active material may react excessively with the electrolyte, or a moisture and oxygen in an air due to a high specific surface area, and life-span and capacity of the secondary battery may be deteriorated. In the anode active material according to exemplary embodiments, the silicon-based active material may have a non-porous structure with a low specific surface area, so that high power and life-span properties of the secondary battery may be provided.

For example, the electrolyte and/or a life-span additive (e.g., fluoroethylene carbonate (FEC) additives) may be injected in an excess amount of the anode active material when fabricating of the secondary battery in order to prevent degradation of the life-span of the secondary battery that would have resulted from the side reaction of the silicon-based active material and the electrolyte. However, in this case, the capacity of the battery may be reduced due to a low reduction potential of the electrolyte and the life-span additive, and cycle properties and high temperature performance may also be deteriorated.

According to exemplary embodiments, the silicon-based active material may have the above-described ranges of the minimum particle diameter (Dmin), the volume average particle diameter (D50) and the specific surface area, so that the side reactions between the anode active material and the electrolyte may be reduced, and cracks of particles may be prevented. Thus, even when a small amount of the electrolyte and/or the life-span additive is included, the power and life-span properties of the battery may be improved. Further, degradation of high-temperature stability and electrochemical performance of the secondary battery due to an excessive amount of the electrolyte and/or life-span additive may be prevented.

In exemplary embodiments, a number average particle diameter (Dn) of the silicon-based active material may be in a range from 1.0 μm to 5.0 μm, and preferably, in certain implementations, may be in a range from 1.0 μm to 4.0 μm. The number average particle size (Dn) refers to, e.g., a particle size at 50% of a cumulative degree of the number of particles in an accumulation from the smallest particles by the number-weighted particle size distribution using a particle size analyzer by a light scattering method.

For example, if the number average particle diameter of the silicon-based active material is less than 1.0 dispersibility of the anode active material in the anode may be degraded. If the number average particle diameter of the silicon-based active material exceeds 5.0 expansion of the active material particles due to the repeated charging and discharging may become greater, and a binding force between the particles may be decreased, thereby reducing the cycle properties.

In some embodiments, a ratio (D50/Dn) of the volume average particle diameter relative to the number average particle diameter of the silicon-based active material may be 10.0 or less, preferably, in certain implementations, 2.0 or less. Within the above range, the particle size distribution of the silicon-based active material may become uniform, and a content of particles having a diameter smaller than the volume average particle diameter (D50) in the silicon-based active material may be reduced. Accordingly, high capacity and high rate properties of the battery may be achieved.

In some embodiments, D10 of the silicon-based active material may be in a range from 1.5 μm to 4.5 μm, and preferably, in certain implementations, from 2.5 μm to 4 μm. D10 may refer to a particle diameter at a volume fraction of 10% of all particles of various diameters in volume of all the particles in the material in an accumulation from the smallest particle to the largest particle when the volume-weighted particle size distribution is measured using a particle size analyzer by a light scattering method.

Within the above range, an increase of an initial irreversible capacity may be prevented, and a current density per unit volume of the electrode may be increased.

In some embodiments, D90 of the silicon-based active material may be in a range from 7 μm to 10 μm, and preferably, in certain implementations, may be in a range from 8 μm to 9 μm. D90 refers to a particle diameter corresponding to a volume fraction of 90% of all particles in the material with different particle diameters in an accumulation from the smallest particle to the largest particle when the volume-weighted particle size distribution is measured using a particle size analyzer by a light scattering method.

Within the above range, a particle size difference between fine particles and granulated particles included in the silicon-based active material may be reduced. Accordingly, the silicon-based active material may have an entirely uniform particle size distribution, and a local variation in the particle diameter in the anode may be prevented, thereby improving cycle properties and energy density.

In some embodiments, the silicon-based active material may include silicon (Si), a silicon oxide (SiOx, 0<x<2), a silicon-metal alloy or a silicon-carbon composite (Si—C). These silicon-based active materials may be used alone or in combination of two or more silicon-based active materials.

In some embodiments, the silicon oxide (SiOx, 0<x<2) may include a lithium compound or a magnesium compound. For example, the SiOx containing the lithium compound or the magnesium compound may be SiOx pretreated with lithium or magnesium. For example, the SiOx containing the lithium compound or the magnesium compound may include lithium silicate or magnesium silicate.

In some embodiments, the silicon-carbon composite may include silicon carbide (SiC) formed by mechanically combining silicon and carbon, or a silicon-carbon particle having a core-shell structure.

In exemplary embodiments, the silicon-based active material may be included in an amount from 5 weight percent (wt %) to 20 wt % based on a total weight of the anode active material. If the amount of the silicon-based active material exceeds 20 wt %, the anode active material may expand due to the repeated charging and discharging, and a short circuit may occur in the battery. If the amount of the silicon-based active material is less than 5 wt %, an amount of the carbon-based active material may be increased relatively to the amount of the silicon-based active material, and an initial efficiency of the battery may be degraded.

Preferably, in certain implementations, the silicon-based active material may be included in an amount of 5 wt % to 15 wt % based on the total weight of the anode active material. In the above range, the poor contact between the active materials and the short circuit in the battery may be prevented while maintaining the high-capacity properties of the battery.

In exemplary embodiments, a specific surface area of the carbon-based active material may be in a range from 0.1 m²/g to 3 m²/g. Preferably, in certain implementations, the specific surface area of the carbon-based active material may be in a range from 0.5 m²/g to 2.5 m²/g, more preferably, in certain implementations, from 1 m²/g to 2 m²/g.

If the specific surface area of the carbon-based active material is less than 0.1 m²/g, an adsorption and release of lithium ions may be interrupted to deteriorate charge/discharge capacity and rapid charge performance. If the specific surface area of the carbon-based active material exceeds 3 m²/g, the contact area between the electrolyte and the active material may be increased, and mechanical and structural stability of the active material may be degraded.

In some embodiments, a volume average particle diameter (D50) of the carbon-based active material may be in a range from 10 μm to 20 μm, and preferably, in certain implementations, may be in a range from 10 μm to 15 μm. For example, if the volume average particle diameter (D50) of the carbon-based active material is less than 10 the carbon-based active material particles may be aggregated with each other or dispersibility of the particles may be degraded. Additionally, an amount of the active material per unit volume may be decreased, and a conductive path may not be sufficiently formed.

If the volume average particle diameter (D50) of the carbon-based active material exceeds a movement distance of lithium ions at an inside of the electrode may become greater, and a reaction and charge/discharge rate may be reduced.

For example, the carbon-based active material may include an amorphous active material such as hard carbon, soft carbon, calcined cokes, mesophase pitch carbide, etc., or a crystalline active material such as natural graphite or artificial graphite. These carbon-based active materials may be used alone or in combination of two or more carbon-based active materials.

Preferably, in certain implementations, the carbon-based active material may include artificial graphite. Artificial graphite may provide a lower capacity than natural graphite, but may have relatively high chemical and thermal stability. Accordingly, artificial graphite may be used as the carbon-based active material, so that high-temperature storage or high-temperature life-span properties of the secondary battery may be improved.

In exemplary embodiments, an amount of the carbon-based active material may be from 75 wt % to 95 wt % based on the total weight of the anode active material. Preferably, in certain implementations, the amount of the carbon-based active material may be from 80 wt % to 90 wt % based on the total weight of the anode active material.

If the amount of the carbon-based active material is less than 75 wt %, a short circuit in the electrode may occur, thereby reducing the life-span and capacity recovery of the secondary battery. If the amount of the carbon-based active material exceeds 95 wt %, the content of the silicon-based active material may be decreased, thereby reducing the capacity and energy density of the secondary battery.

<Anode Composition>

An anode composition according to exemplary embodiments may include the anode active material according to the above-described embodiments, and a conductive material. The conductive material may promote an electron movement between the active material particles.

In exemplary embodiments, the anode composition may include the anode active material and carbon nanotubes (CNTs). A power and a charging/discharging rate of the battery may be improved by the carbon nanotube having high energy density and high conductivity. Additionally, the carbon nanotubes may be distributed between the active material particles to surround the active material particles, so that a conductive network may be easily formed in the electrode.

In some embodiments, a content of the carbon nanotube may be from 0.05 wt % to 1.5 wt %, preferably, in certain implementations, from 0.1 wt % to 1.5 wt % based on a total solid content of the anode composition. For example, the term “solid content” used herein may refer to a content of a component excluding a solvent or a solid material in the anode composition.

As the content of the carbon nanotubes in the anode composition decreases, conductivity of electron/ion may decrease to increase an internal resistance of the electrode. If the content of the carbon nanotube is increased to reduce the resistance, the content of the anode active material may be relatively decreased to degrade capacity and power properties of the battery.

In the anode composition according to exemplary embodiments, mobility of electrons and ions may be improved by the anode active material, and thus, a diffusion resistance of lithium ions may become low even with a small amount of the carbon nanotube. Therefore, the content of the anode active material in the anode composition may be increased, so that the capacity and life-span properties of the battery may be improved.

In some embodiments, the anode composition may further include a graphite-based conductive material; a carbon-based conductive material such as acetylene black, Ketjen black, carbon black, etc.; a metal-based conductive material such as tin, tin oxide, zinc oxide, titanium oxide, a metal fiber; and/or a carbon nanofiber (CNF) as a conductive material. These materials may be used alone or in combination of two or more materials.

For example, the content of the graphite-based conductive material may be in a range from 0.1 wt % to 1 wt % based on the total solid content of the anode composition, and the content of the carbon-based conductive material may be in a range from 1 wt % to 5 wt % based on the total solid content of the anode composition.

In some embodiments, a content of the anode active material may be in a range from 85 wt % to 99 wt %, and preferably, in certain implementations, may be in a range from 90 wt % to 98 wt % based on the total solid content of the anode composition. Within the above range, the power and charge/discharge capacity of the battery may be improved.

In exemplary embodiments, the anode composition may further include at least one of a solvent, a binder, a thickener and a dispersive agent. For example, the anode composition may be prepared in the form of a slurry in which the above-described anode active material and the conductive material are mixed and stirred in the solvent.

In some embodiments, the binder may includevinylidene fluoride-hexafluoropropylene copolymer (PVDF-co-HFP), polyvinylidenefluoride (PVDF), polyacrylonitrile, polymethylmethacrylate, polyvinylalcohol, polyvinylpyrrolidone, polyethylene, polypropylene, polyacrylic acid or styrene-butadiene rubber (SBR). These may be used alone or in combination of two or more.

For example, the binder may include an acrylic polymer binder, an SBR-based binder or a mixture thereof. In this case, the expansion/contraction of the silicon-based active material may be suppressed, and decomposition and damages of the active material may be prevented. Further, the distance between the anode active material particles may be controlled to reduce a resistance of the anode composition. Thus, stable capacity and power may be maintained for a long period even during the repeated charging and discharging.

In some embodiments, the thickener may include carboxymethyl cellulose (CMC), methyl cellulose (MC), hydroxypropyl cellulose (HPC), methyl hydroxypropyl cellulose (MHPC), etc.

In some embodiments, a content of the binder may be in a range from 1 wt % to 5 wt % based on the total solid content of the anode composition. In an embodiment, a content of the thickener may be in a range from 0.1 wt % to 5 wt % based on the total solid content of the anode composition.

<Lithium Secondary Battery>

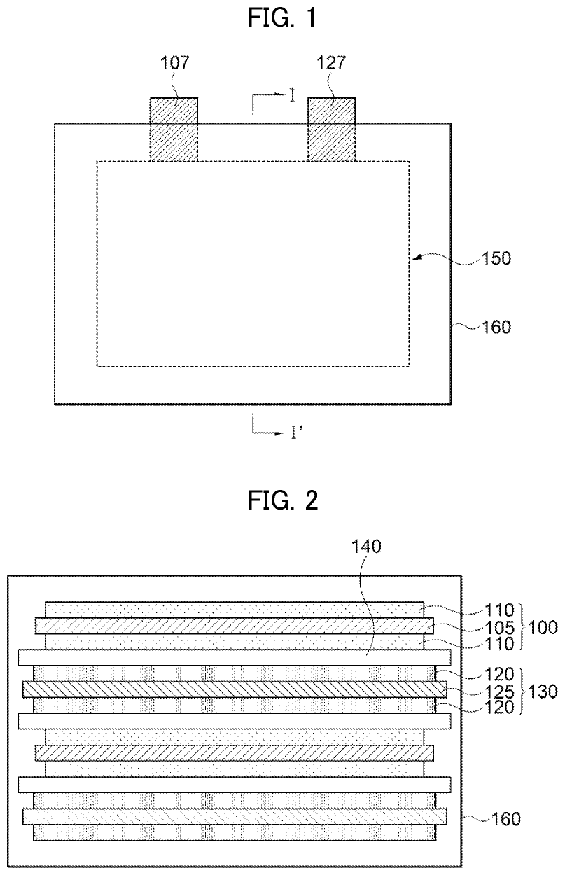

FIGS. 1 and 2 show a schematic top planar view and a schematic cross-sectional view, respectively, illustrating a secondary battery according to exemplary embodiments. For example, FIG. 2 is a cross-sectional view taken along a line I-I′ of FIG. 1 in a thickness direction of the lithium secondary battery.

For convenience of descriptions, illustration of a cathode and an anode is omitted in FIG. 2.

Referring to FIGS. 1 and 2, the secondary battery may be provided as a lithium secondary battery. In exemplary embodiments, the secondary battery may include an electrode assembly 150 and a case 160 accommodating the electrode assembly 150. The electrode assembly 150 may include an anode 130, a cathode 100 and a separation layer 140.

The cathode 100 may include a cathode current collector 105 and a cathode active material layer 110 formed on at least one surface of the cathode current collector 105. In exemplary embodiments, the cathode active material layer 110 may be formed on both surfaces (e.g., upper and lower surfaces) of the cathode current collector 105. For example, the cathode active material layer 110 may be coated on each of the upper and lower surfaces of the cathode current collector 105, and may be directly coated on the surface of the cathode current collector 105.

The cathode current collector 105 may include stainless-steel, nickel, aluminum, titanium, copper or an alloy thereof. Preferably, in certain implementations, aluminum or an alloy thereof may be used.

The cathode active material layer 110 may include a lithium metal oxide as a cathode active material. In exemplary embodiments, the cathode active material may include a lithium (Li)-nickel (Ni)-based oxide.

In some embodiments, the lithium metal oxide included in the cathode active material layer 110 may be represented by Chemical Formula 1 below.

Li₁₊ₐNi_{1-(x+y)}CoₓM_{y}O₂ [Chemical Formula 1]

In the Chemical Formula 1 above, −0.05≤a≤0.15, 0.01≤x≤0.2, 0≤y≤0.2, and M may include at least one element selected from Mn, Mg, Sr, Ba, B, Al, Si, Ti, Zr and W. In an embodiment, 0.01≤x≤0.20, 0.01≤y≤0.15 in Chemical Formula 1.

Preferably, in certain implementations, in Chemical Formula 1, M may be manganese (Mn). In this case, nickel-cobalt-manganese (NCM)-based lithium oxide may be used as the cathode active material.

For example, nickel (Ni) may serve as a metal related to a capacity of a lithium secondary battery. As the content of nickel increases, capacity of the lithium secondary battery may be improved. However, if the content of nickel is excessively increased, life-span may be decreased, and mechanical and electrical stability may be degraded.

For example, cobalt (Co) may serve as a metal related to conductivity or resistance. In an embodiment, M may include manganese (Mn), and Mn may serve as a metal related to mechanical and electrical stability of the lithium secondary battery.

Capacity, power, low resistance and life-span stability may be improved together from the cathode active material layer 110 by the above-described interaction between nickel, cobalt and manganese.

For example, a cathode slurry may be prepared by mixing and stirring the cathode active material with a binder, a conductive material and/or a dispersive agent in a solvent. The cathode slurry may be coated on the cathode current collector 105, and then dried and pressed to form the cathode active material layer 110.

The binder may include an organic based binder such as a polyvinylidene fluoride-hexafluoropropylene copolymer (PVDF-co-HFP), polyvinylidenefluoride (PVDF), polyacrylonitrile, polymethylmethacrylate, polyvinylalcohol, polyvinylpyrrolidone, polyethylene, polypropylene, polyacrylic acid, etc., or an aqueous based binder such as styrene-butadiene rubber (SBR) that may be used with a thickener such as carboxymethyl cellulose (CMC).

For example, a PVDF-based binder may be used as a cathode binder. In this case, an amount of the binder for forming the cathode active material layer 110 may be reduced, and an amount of the cathode active material or lithium metal oxide particles may be relatively increased. Thus, capacity and power of the lithium secondary battery may be further improved.

For example, the conductive material may include a carbon-based material such as graphite, carbon black, a carbon nanofiber, a carbon nanotube, etc., and/or a metal-based material such as tin, tin oxide, zinc oxide, titanium oxide, a metal fiber, etc.

In some embodiments, an electrode density of the cathode 100 may be in a range from 3.0 g/cc to 3.9 g/cc, preferably, in certain implementations, from 3.2 g/cc to 3.8 g/cc.

The anode 130 may include an anode current collector 125 and an anode active material layer 120 formed on at least one surface of the anode current collector 125. In exemplary embodiments, the anode active material layer 120 may be formed on both surfaces (e.g., upper and lower surfaces) of the anode current collector 125. The anode active material layer 120 may be coated on each of the upper and lower surfaces of the anode current collector 125. For example, the anode active material layer 120 may directly contact the surface of the anode current collector 125.

The anode current collector 125 may include gold, stainless steel, nickel, aluminum, titanium, copper, or an alloy thereof, and preferably, in certain implementations, may include copper or a copper alloy.

In some embodiments, the anode composition according to the above-described exemplary embodiments may be coated on the anode current collector 125, dried and pressed to form the anode active material layer 120.

In exemplary embodiments, an electrode density of the anode 130 may be in a range from 1.0 g/cc to 1.9 g/cc.

In some embodiments, an area and/or a volume of the anode 130 (e.g., a contact area with the separation layer 140) may be greater than that of the cathode 100. Thus, lithium ions generated from the cathode 100 may be easily transferred to the anode 130 without a loss by, e.g., precipitation or sedimentation to further improve power and capacity of the secondary battery.

The separation layer 140 may be interposed between the cathode 100 and the anode 130. The separation layer 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separation layer 140 may also include a non-woven fabric formed from a glass fiber with a high melting point, a polyethylene terephthalate fiber, or the like.

The separation 140 may extend between the cathode 100 and the anode 130, and may be folded and wound along the thickness direction of the lithium secondary battery. Accordingly, a plurality of the anodes 130 and the cathodes 100 may be stacked in the thickness direction using the separation layer 140.

In exemplary embodiments, an electrode cell may be defined by the cathode 100, the anode 130 and the separation layer 140, and a plurality of the electrode cells may be stacked to form the electrode assembly 150 that may have e.g., a jelly roll shape. For example, the electrode assembly 150 may be formed by winding, laminating or folding of the separation layer 140.

The electrode assembly 150 may be accommodated together with an electrolyte in the case 160 to define the lithium secondary battery. The case 160 may include, e.g., a pouch, a can, etc.

In exemplary embodiments, a non-aqueous electrolyte may be used as the electrolyte. The non-aqueous electrolyte solution may include a lithium salt and an organic solvent. The lithium salt may be represented by Li⁺X⁻, and an anion of the lithium salt X⁻ may include, e.g., F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxy ethane, diethoxy ethane, vinylene carbonate, sulfolane, gamma-butyrolactone, propylene sulfite, tetrahydrofuran, etc. These materials may be used alone or in a combination of two or more materials.

To avoid a reduction of the life-span of the secondary battery due to the silicon-based active material, a life-span additive such as fluoroethylene carbonate (FEC) may be included in an excessive amount in the electrolyte. However, in this case, the capacity of the battery may be reduced due to a low reduction potential of the life-span additive, and cycle properties and high-temperature performance may be deteriorated.

In the anode active material and the anode composition according to exemplary embodiments, the silicon-based active material having a high minimum particle diameter (Dmin) and a low specific surface area may be used to improve long-term storage stability.

For example, the silicon-based active material may have a minimum particle diameter of 0.5 μm or more, so that the side reaction between the anode active material and the electrolyte may be suppressed. Therefore, even though a small amount of the life-span additive is included in the electrolyte, the cycle properties may not be deteriorated. Further, the content of the life-span additive may be reduced so that the high-temperature performance of the secondary battery may be improved.

As illustrated in FIG. 1, electrode tabs (a cathode tab and an anode tab) may protrude from the cathode current collector 105 and the anode current collector 125 included in each electrode cell to one side of the case 160. The electrode tabs may be welded together with the one side of the case 160 to be connected to an electrode lead (a cathode lead 107 and an anode lead 127) that may be extended or exposed to an outside of the case 160.

FIG. 1 illustrates that the cathode lead 107 and the anode lead 127 are positioned at the same side of the lithium secondary battery or the case 160, but the cathode lead 107 and the anode lead 127 may be formed at opposite sides to each other.

For example, the cathode lead 107 may be formed at one side of the case 160, and the anode lead 127 may be formed at the other side of the case 160.

The lithium secondary battery may be manufactured in, e.g., a cylindrical shape using a can, a square shape, a pouch shape or a coin shape.

Hereinafter, specific examples of implementations or embodiments of the disclosed technology are described to more concretely illustrate various features of the disclosed technology. Various alterations and modifications of the disclosed examples are possible based on what is disclosed in this patent document.

### Synthesis Example

(1) Preparation of Silicon-Based Active Material

Silicon (Si) particles were heated to form a melt, and then rapidly solidified to form a solidified body. The obtained solid was put into a ball mill grinder, and a ball milling was performed at 300 rpm for 24 hours using a zirconia ball having a particle diameter of 3 mm to obtain a silicon-based active material powder. The obtained powder was passed through a 400-mesh stainless steel mesh to obtain a silicon-based active material A-1 having a particle size distribution and a specific surface area as shown in Table 1 below.

In the ball milling process, silicon-based active materials A-2 to A-6 satisfying the particle size distribution and specific surface area of Table 1 below were obtained by varying a particle diameter of the zirconia ball, a rotational speed and a process time.

(2) Measurement of Particle Size Distribution

A particle size distribution of the obtained silicon-based active material was obtained by dispersing the silicon-based active material in a dispersion medium (10 wt % aqueous dispersion of sodium hexametaphosphate ((NaPO₃)₆)), and then measuring a diffraction pattern difference according to a particle size by a laser diffraction particle size analyzer (Microtrac S3500).

Dmin was measured as the smallest diameter among the measured particle diameters, and a number average particle diameter (Dn) was measured by calculating the particle diameter at a point of 50% in a cumulative distribution of the number of particles. Further, D10, D50 and D90 were measured by calculating particle diameters at points of 10%, 50% and 90% of volume fractions.

(3) Measurement of Specific Surface Area

The specific surface area of the obtained silicon-based active material was measured by a BET method based on an adsorbed amount of nitrogen gas using a specific surface area measuring device (BELSORP-mino II).

The results are shown in Table 1 below.

TABLE 1

| | Dmin | D10 | D50 | D90 | Dn | BET |
|---|---|---|---|---|---|---|
| No. | (μm) | (μm) | (μm) | (μm) | (μm) | (m²/g) |
| A-1 | 2.2 | 3.7 | 5.7 | 8.7 | 3.8 | 1.5 |
| A-2 | 1.6 | 2.9 | 5.2 | 8.6 | 3.5 | 1.8 |
| A-3 | 0.9 | 1.6 | 4.7 | 7.2 | 2.1 | 2.3 |
| A-4 | 0.2 | 1.4 | 5.0 | 9.9 | 0.3 | 4.3 |
| A-5 | 0.1 | 1.0 | 6.7 | 10.1 | 0.2 | 5.1 |
| A-6 | 0.4 | 1.5 | 5.1 | 8.9 | 0.9 | 3.9 |

FIGS. 3 and 4 are graphs showing volume-weighted particle size distributions and number-weighted particle size distributions, respectively, of silicon-based active materials A-1, A-2 and A-4.

Referring to FIGS. 3 and 4, as the content of fine particles increased, a difference between the volume average particle diameter (D50) and the number average particle diameter (Dn) increased. Thus, as a ratio of the volume average particle diameter relative to the number average particle diameter became closer to 1, distribution of the fine particles were reduced in the active material.

### Examples and Comparative Examples

(1) Preparation of Anode and Cathode

Mixtures having compositions and contents shown in Table 2 below were prepared as anode active materials. The prepared anode active material, a conductive material, a binder, a thickener and a dispersive agent were mixed as shown in Table 2 to form an anode composition. The anode composition was coated on a Cu foil, dried and pressed to prepare an anode having a mixture density of 9.35 mg/cm² (based on a cross-section) and 1.7 g/cc.

LiNi_{0.8}Co_{0.08}Mn_{0.04}O₂ as a cathode active material, a CNT material as a conductive material and polyvinylidene fluoride (PVDF) as a binder were mixed in a weight ratio of 98.3:0.6:1.1 to prepare a cathode slurry. The cathode slurry was coated on an aluminum substrate, dried and pressed to prepare a cathode.

(2) Fabrication of Secondary Battery

The prepared cathode and the anode were stacked with a polyethylene (PE) separator (13 μm) interposed therebetween to form an electrode cell, and the electrode cells were stacked to form an electrode assembly. The electrode assembly was accommodated in a pouch and electrode tab portions were fused.

Thereafter, a 1.15M LiPF₆ electrolyte solution was prepared using a mixed solvent of ethylene carbonate/ethylmethyl carbonate (EC/EMC, 25/75; volume ratio). A life-span additive (FEC) was added to the electrolyte solution in an amount (wt %) as shown in Table 2 based on a total weight of the electrolyte solution. The electrolyte solution was injected into the electrode assembly and sealed to manufacture a secondary battery.

TABLE 2

| | Anode Composition (wt %) | | | | | | Life-span |
|---|---|---|---|---|---|---|---|
| | silicon-based | carbon-based | conductive | | | dispersive | Additive |
| No. | active material | active material | material | binder | thickener | agent | (wt %) |
| Example 1 | 9 (A-1) | 88.05 (B-1) | 0.1 (C-1) | 1.5 | 1.2 | 0.15 | 3 |
| Example 2 | 9 (A-1) | 88.05 (B-1) | 0.1 (C-1) | 1.5 | 1.2 | 0.15 | 5 |
| Example 3 | 9 (A-2) | 88.05 (B-1) | 0.1 (C-1) | 1.5 | 1.2 | 0.15 | 3 |
| Example 4 | 9 (A-2) | 88.05 (B-1) | 0.1 (C-1) | 1.5 | 1.2 | 0.15 | 5 |
| Example 5 | 9 (A-1) | 88.05 (B-2) | 0.1 (C-1) | 1.5 | 1.2 | 0.15 | 3 |
| Example 6 | 9 (A-1) | 88.05 (B-2) | 0.1 (C-1) | 1.5 | 1.2 | 0.15 | 5 |
| Example 7 | 9 (A-2) | 88.05 (B-2) | 0.1 (C-1) | 1.5 | 1.2 | 0.15 | 3 |
| Example 8 | 9 (A-3) | 88.05 (B-1) | 0.1 (C-1) | 1.5 | 1.2 | 0.15 | 3 |
| Example 9 | 9 (A-3) | 88.05 (B-2) | 0.1 (C-1) | 1.5 | 1.2 | 0.15 | 3 |
| Example 10 | 9 (A-1) | 85.30 (B-1) | 3 (C-2) | 1.5 | 1.2 | — | 5 |
| Example 11 | 9 (A-2) | 85.30 (B-1) | 3 (C-2) | 1.5 | 1.2 | — | 5 |
| Example 12 | 9 (A-1) | 88.05 (B-3) | 0.1 (C-1) | 1.5 | 1.2 | 0.15 | 3 |
| Example 13 | 9 (A-2) | 88.05 (B-3) | 0.1 (C-1) | 1.5 | 1.2 | 0.15 | 3 |
| Comparative | 9 (A-4) | 88.05 (B-1) | 0.1 (C-1) | 1.5 | 1.2 | 0.15 | 3 |
| Example 1 | | | | | | | |
| Comparative | 9 (A-4) | 88.05 (B-1) | 0.1 (C-1) | 1.5 | 1.2 | 0.15 | 5 |
| Example 2 | | | | | | | |
| Comparative | 9 (A-4) | 88.05 (B-1) | 0.1 (C-1) | 1.5 | 1.2 | 0.15 | 7 |
| Example 3 | | | | | | | |
| Comparative | 9 (A-4) | 88.05 (B-2) | 0.1 (C-1) | 1.5 | 1.2 | 0.15 | 3 |
| Example 4 | | | | | | | |
| Comparative | 9 (A-5) | 88.05 (B-1) | 0.1 (C-1) | 1.5 | 1.2 | 0.15 | 3 |
| Example 5 | | | | | | | |
| Comparative | 9 (A-5) | 88.05 (B-2) | 0.1 (C-1) | 1.5 | 1.2 | 0.15 | 3 |
| Example 6 | | | | | | | |
| Comparative | 9 (A-6) | 88.05 (B-1) | 0.1 (C-1) | 1.5 | 1.2 | 0.15 | 3 |
| Example 7 | | | | | | | |
| Comparative | 9 (A-4) | 85.30 (B-1) | 3 (C-2) | 1.5 | 1.2 | — | 5 |
| Example 8 | | | | | | | |

Specific components listed in Table 2 are as follows.

Silicon-Based Active Material

Silicon-based active materials A-1 to A-6 synthesized in the above Synthesis Example

Carbon-Based Active Material

1) B-1: artificial graphite having the following particle size distribution and specific surface area:

D10: 6.0 μm, D50: 13.1 μm, D90: 24.0 μm, BET: 1.60 m²/g.

2) B-2: artificial graphite having the following particle size distribution and specific surface area:

D10: 6.5 μm, D50: 14.5 μm, D90: 30.9 μm, BET: 3.20 m²/g.

3) B-3: natural graphite having the following particle size distribution and specific surface area:

D10: 6.0 μm, D50: 13.1 μm, D90: 24.0 μm, BET: 1.60 m²/g.

Conductive Material

1) C-1: carbon nanotube

2) C-2: carbon black

### Experimental Example

(1) Evaluation on Life-Span Property

A charging (CC/CV, 0.3C, an upper limit voltage 4.2V, 0.05C cut-off) and a discharging (CC, 0.3C, a lower limit voltage 2.5V cut-off) at 25° C. as one cycle for secondary batteries according to Examples and Comparative Examples were repeated at an interval of 10 minutes. Thereafter, a capacity retention was measured as a percentage of a discharge capacity measured at a 1,000th cycle relative to a discharge capacity at a 1st cycle.

When the discharge capacity plunged before reaching the 1,000th cycle to disable the measurement of the discharge capacity at the 1000 cycle, a time when the life-span plunged time was measured. The life-span plunge means a case that the capacity retention dropped by 10% or more within 100 cycles.

(2) Evaluation on High-Temperature Storage

The secondary batteries according to Examples and Comparative Examples were charged (CC/CV 0.1C 4.3V 0.05C CUT-OFF), and then stored in an oven at 60° C. for 20 weeks. Thereafter, an amount of gas generated at the inside of the secondary battery was measured at 4-week intervals. The amount of gas was calculated as a volume change of the secondary battery. A time when the amount of gas reached 400 ml was evaluated as a venting time of the secondary battery.

The evaluation results are shown in Table 3 below.

TABLE 3

| | Life-span | | | | | | |
|---|---|---|---|---|---|---|---|
| | property | | | | | | |
| | (@1000 cycle) | | | | | | |
| | Life- | capac- | | | | | |
| | span | ity | | | | | |
| | plunge | reten- | Gas generation (ml) | | | | |
| | time | tion | 4 | 8 | 12 | 16 | Venting |
| No. | (cycle) | (%) | week | week | week | week | time |
| Example 1 | — | 87.4 | 122 | 203 | 283 | 345 | 19 weeks |
| Example 2 | — | 87.5 | 148 | 256 | 340 | — | 15 weeks |
| Example 3 | — | 86.6 | 127 | 212 | 289 | 354 | 19 weeks |
| Example 4 | — | 86.9 | 150 | 258 | 347 | — | 15 weeks |
| Example 5 | 900 | — | 129 | 215 | 292 | 359 | 18 weeks |
| Example 6 | — | 80.3 | 153 | 261 | 348 | — | 15 weeks |
| Example 7 | 830 | — | 131 | 219 | 295 | 360 | 18 weeks |
| Example 8 | — | 85.1 | 130 | 220 | 299 | 361 | 18 weeks |
| Example 9 | 780 | — | 133 | 222 | 305 | 365 | 18 weeks |
| Example 10 | 550 | — | 155 | 266 | 358 | — | 15 weeks |
| Example 11 | 530 | — | 157 | 267 | 360 | — | 14 weeks |
| Example 12 | — | 80.3 | 131 | 212 | 289 | 357 | 19 weeks |
| Example 13 | — | 79.2 | 136 | 221 | 297 | 362 | 18 weeks |
| Comparative | 350 | — | 142 | 233 | 312 | 384 | 17 weeks |
| Example 1 | | | | | | | |
| Comparative | 510 | — | 158 | 269 | 366 | — | 14 weeks |
| Example 2 | | | | | | | |
| Comparative | 710 | — | 206 | 353 | — | — | 10 weeks |
| Example 3 | | | | | | | |
| Comparative | 270 | — | 148 | 245 | 329 | 392 | 16 weeks |
| Example 4 | | | | | | | |
| Comparative | 230 | — | 150 | 248 | 338 | 398 | 16 weeks |
| Example 5 | | | | | | | |
| Comparative | 190 | — | 153 | 256 | 348 | — | 15 weeks |
| Example 6 | | | | | | | |
| Comparative | 450 | — | 139 | 229 | 310 | 379 | 17 weeks |
| Example 7 | | | | | | | |
| Comparative | 240 | — | 173 | 281 | 375 | — | 14 weeks |
| Example 8 | | | | | | | |

Referring to Table 3, the secondary batteries of Examples including the anode active material as described above provided improved life-span property and high-temperature stability. The secondary batteries of Comparative Examples in which the anode active material within the predetermined ranges of particle diameter and specific surface area was used provided degraded life-span property and high-temperature stability.

In the secondary battery of Comparative Example 3, sufficient life-span property was not achieved even though an excessive amount of the life-span additive was included, and a discharge capacity plunge occurred before reaching the 1,000th cycle. Further, high-temperature storage property was deteriorated due to the excessive amount of the life-span additive.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Only a few implementations and examples are described and other implementations, enhancements and variations can be made based on what is described and illustrated in this patent document.

What is claimed is:

1. An anode active material, comprising:
a carbon-based active material; and
a silicon-based active material having a minimum particle diameter (Dmin) in a range from 0.5 μm to 2.5 μm, a volume average particle diameter (D50) in a range from 3.0 μm to 7.0 μm and a specific surface area in a range from 0.1 m²/g to 2.5 m²/g.

2. The anode active material of claim 1, wherein a volume fraction of particles having a diameter of 1 μm or less in the silicon-based active material is 5% or less.

3. The anode active material of claim 2, wherein the minimum particle diameter (Dmin) of the silicon-based active material is in a range from 1.5 μm to 2.5 μm.

4. The anode active material of claim 1, wherein a D10 of the silicon-based active material is in a range from 1.5 μm to 4.5 μm, where the D10 is a particle diameter at a volume fraction of 10% in an accumulation from the smallest particle to the largest particle.

5. The anode active material of claim 1, wherein a D90 of the silicon-based active material in a range from 7 μm to 10 μm, where the D90 is a particle diameter at a volume fraction of 90% in an accumulation from the smallest particle to the largest particle.

6. The anode active material of claim 1, wherein a number average particle diameter (Dn) of the silicon-based active material is in a range from 1.0 μm to 5.0 μm.

7. The anode active material of claim 1, wherein a specific surface area of the carbon-based active material is in a range from 0.1 m²/g to 3 m²/g.

8. The anode active material of claim 1, wherein a volume average particle diameter (D50) of the carbon-based active material is in a range from 10 μm to 15 μm.

9. The anode active material of claim 1, wherein an amount of the silicon-based active material is in a range from 5 wt % to 20 wt % based on a total weight of the anode active material.

10. An anode composition, comprising:
an anode active material of claim 1; and
a carbon nanotube (CNT) material that includes carbon nanotubes.

11. The anode composition of claim 10, wherein a content of the carbon nanotube (CNT) material is in a range from 0.05 wt % to 1.5 wt % based on a total solid content of the anode composition.

12. The anode composition of claim 10, wherein a content of the carbon nanotube (CNT) material is in a range from 0.1 wt % to 0.5 wt % based on a total solid content of the anode composition.

13. The anode composition of claim 10, further comprising at least one selected from the group consisting of a solvent, a binder, a thickener and a dispersive agent.

14. A lithium secondary battery, comprising:
an anode comprising the anode active material of claim 1; and
a cathode facing the anode.

15. The lithium secondary battery of claim 14, wherein a volume fraction of particles having a diameter of 1 μm or less in the silicon-based active material is 5% or less.

16. The lithium secondary battery of claim 14, wherein 10% of particles in the silicon-based active material by volume has a diameter not greater than a diameter in a range from 1.5 μm to 4.5 μm.

17. The lithium secondary battery of claim 14, wherein 90% of particles in the silicon-based active material by volume has a diameter not greater than a diameter in a range from 7 μm to 10 μm.

18. The lithium secondary battery of claim 14, wherein a number average particle diameter (Dn) of the silicon-based active material is in a range from 1.0 μm to 5.0 μm.
